(19) United States
(12) Patent Application Publication
(10) Pub. No.: US 2026/0128533 A1
(43) Pub. Date: May 7, 2026

(54) COMBINED ANTENNA AND ELECTRONIC DEVICE

(71) Applicant: Quectel Wireless Solutions Co., Ltd., Shanghai (CN)

(72) Inventors: Lijun WANG, Shanghai (CN); He TU, Shanghai (CN)

(73) Assignee: Quectel Wireless Solutions Co., Ltd., Shanghai (CN)

(21) Appl. No.: 19/412,731

(22) Filed: Dec. 8, 2025

Related U.S. Application Data
(63) Continuation of application No. PCT/CN2023/114503, filed on Aug. 23, 2023.

(30) Foreign Application Priority Data
Jun. 9, 2023 (CN) 202310686472.6

(51) Int. Cl. H01Q 21/28; H01Q 1/22; H01Q 1/52

(52) U.S. Cl. CPC H01Q 21/28; H01Q 1/22; H01Q 1/521

(57) ABSTRACT

In a combined antenna, a first antenna and a plurality of second antennas are installed on the side of a circuit board away from a base, and a plurality of third antennas are installed on the side of the circuit board facing the base, the second antennas and the third antennas being alternately arranged on the two sides of the circuit board.

### CROSS-REFERENCE TO RELATED APPLICATIONS

The present application is a continuation of International Application No. PCT/CN2023/114503, filed on Aug. 23, 2023, which claims priority to Chinese Patent Application No. 202310686472.6, filed on Jun. 9, 2023. All of the aforementioned applications are incorporated herein by reference in their entireties.

### TECHNICAL FIELD

The present application relates to the technical field of antennas, in particular to a combined antenna and an electronic device.

### BACKGROUND

The Internet of Things refers to a network which allows all ordinary physical objects that can be independently addressed to interconnect with each other. In an Internet of Things system, an object needs to communicate with various objects around it, so various different types of antennas need to be configured to meet communication needs of different communication objects.

In conventional antennas, one antenna only supports receiving and sending of one type of signal. When a communication system needs a plurality of antennas, a plurality of independent antennas need to be installed in the communication system. However, in a practical application, it is difficult for the communication system to give a large enough space to install the plurality of antennas.

### SUMMARY

Embodiments of the present application are directed to providing a combined antenna and an electronic device, as described below in the following aspects.

In a first aspect, a combined antenna is provided, including a circuit board, a base, and a connector assembly. The circuit board is fixedly connected with the base, a side of the circuit board away from the base includes a first antenna and a plurality of second antennas, a side of the circuit board facing the base includes a plurality of third antennas, the first antenna is located in a central area of the side of the circuit board away from the base, the plurality of second antennas are located around the first antenna, and the second antennas and the third antennas are alternately arranged on two sides of the circuit board. The connector assembly is connected with the first antenna, each of the second antennas, and each of the third antennas respectively through the circuit board.

In one of the embodiments, the plurality of second antennas are distributed at equal intervals.

In one of the embodiments, a distance from a target antenna in the third antennas to an adjacent third antenna is greater than a distance from a non-target antenna in the third antennas to an adjacent third antenna.

In one of the embodiments, the number of the second antennas is equal to the number of the third antennas.

In one of the embodiments, the circuit board includes a substrate and a copper strip, wherein the copper strip is arranged on a side of the substrate away from the base, the copper strip is polygonal, and one second antenna or one third antenna is distributed in an area corresponding to each edge of the copper strip.

In one of the embodiments, a length of an edge of the copper strip corresponding to an area where each of the second antennas is located is greater than a length of an edge of the copper strip corresponding to an area where each of the third antennas is located.

In one of the embodiments, the copper strip is octagonal.

In one of the embodiments, the combined antenna further includes an antenna bracket. The antenna bracket is arranged between the second antennas and the circuit board.

In one of the embodiments, the combined antenna further includes a first housing and a second housing, wherein the first housing and the second housing are fastened to form an accommodating cavity, the circuit board is located in the accommodating cavity, the second housing includes a penetrating hole, and the base is located in the penetrating hole and connected with the second housing.

In a second aspect, an electronic device is provided, including the combined antenna as described in any one of the first aspect above.

### BRIEF DESCRIPTION OF THE DRAWINGS

FIG. 1 shows a schematic structural diagram of a combined antenna provided by an embodiment of the present application.

FIG. 2 shows a schematic structural diagram of a base provided by an embodiment of the present application.

FIG. 3 shows a first schematic diagram of a circuit board provided by an embodiment of the present application.

FIG. 4 shows a second schematic diagram of a circuit board provided by an embodiment of the present application.

FIG. 5 shows a schematic diagram of a connection between a second antenna and an antenna bracket.

FIG. 6 shows a schematic diagram of a connecting sheet corresponding to a third antenna.

FIG. 7 shows a first schematic diagram of an overall structure of a combined antenna provided by an embodiment of the present application.

FIG. 8 shows a schematic structural diagram of another base provided by an embodiment of the present application.

FIG. 9 shows a second schematic diagram of an overall structure of a combined antenna provided by an embodiment of the present application.

FIG. 10 shows a structural block diagram of an electronic device.

### DETAILED DESCRIPTION OF THE EMBODIMENTS

Technical solutions in embodiments of the present application will be clearly and completely described below in conjunction with accompanying drawings in the embodiments of the present application. Apparently, the described embodiments are only part of the embodiments of the present application, not all of them.

It needs to be noted that, in implementations, unless there is a specific definition on articles in the text, “one,” “a,” “said,” and “the” may also include plural forms. If there are descriptions involving “first,” “second,” “third,” etc. in the embodiments of the present disclosure, the descriptions of “first,” “second,” “third,” etc. are used only for the purpose of description, and cannot be construed as indicating or implying their relative importance or implicitly specifying the quantity of indicated technical features. Therefore, a feature defined by “first” and “second” may explicitly indicate or implicitly include at least one of such features.

With the development of an Internet of Things technology, requirements of communication systems for antennas are increasingly diverse. For example, requirements for antenna types, antenna frequency bands, antenna power, etc. are increasingly diversified. When one communication system needs a plurality of antennas, one mode is to configure a plurality of independent antennas in the communication system, and each antenna may independently receive and send one type of signal. However, the plurality of independent antennas are prone to interfere with each other, affecting the transmission of signals. Moreover, a space provided by the communication system for installing the antennas is limited. In a practical application, it is difficult for the communication system to give a large enough space to install a required number of antennas. Another mode is to use a combined antenna. Existing combined antennas are mostly five-in-one antennas, four-in-one antennas, etc., wherein a five-in-one antenna means that five antennas are combined together, and a four-in-one antenna means that four antennas are combined together. However, these combined antennas include few antennas, and have small frequency band coverages, making it difficult to meet increasingly developing communication needs. Currently, the prior art proposes a seven-in-one antenna, but the antenna has a large size, supports fewer frequency bands, and is mostly designed for specific communication systems.

Therefore, it is necessary to propose a combined antenna with a higher integration level and a wider frequency band coverage to solve the above technical problems.

In order to solve the above technical problems, an embodiment of the present application provides a combined antenna, including a circuit board, a base, and a connector assembly. The circuit board is fixedly connected with the base, a side of the circuit board away from the base includes a first antenna and a plurality of second antennas, a side of the circuit board facing the base includes a plurality of third antennas, the first antenna is located in a central area of the side of the circuit board away from the base, the plurality of second antennas are located around the side of the circuit board away from the base, and the second antennas and the third antennas are alternately arranged on two sides of the circuit board. The connector assembly is connected with the first antenna, the plurality of second antennas, and the plurality of third antennas through the circuit board. In this embodiment, the first antenna and the second antennas, as well as the third antennas are arranged on the two sides of the circuit board, such a distribution mode can more reasonably use an internal space of the combined antenna and improve the isolation among the antennas, so as to miniaturize the combined antenna.

The combined antenna provided by the embodiment of the present application is described below in conjunction with accompanying drawings.

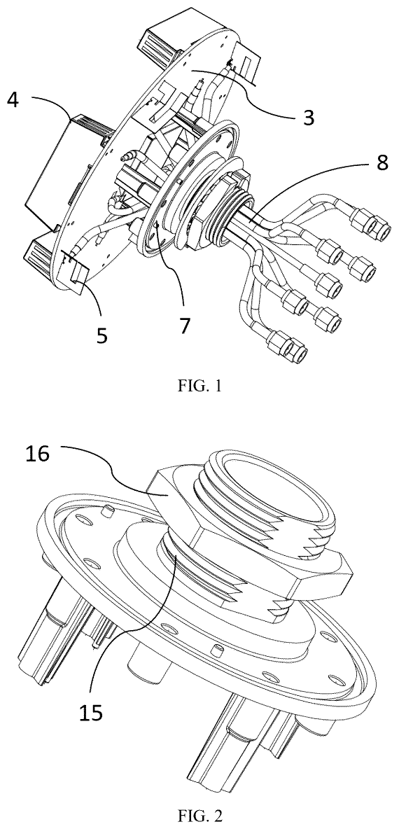

As shown in FIG. 1, FIG. 1 shows a schematic structural diagram of a combined antenna provided by an embodiment of the present application. The combined antenna includes a circuit board 3, a base 7, and a connector assembly 8. The circuit board 3 is fixedly connected with the base 7.

In some implementations, as shown in FIG. 2, FIG. 2 shows a schematic structural diagram of a base provided by an embodiment of the present application. The base 7 includes a chassis. A plurality of support columns are arranged on one side of the chassis. The circuit board 3 is arranged on the plurality of support columns. A threaded column 15 and a nut 16 are arranged on the other side of the chassis, and the combined antenna may be installed onto an electronic device through the threaded column 15 and the nut 16. In some implementations, as shown in FIG. 1, the circuit board 3 is fixed to the base 7 through screws. In some implementations, the base 7 is connected to a central area of the circuit board 3. In some implementations, the connector assembly 8 is located in the threaded column of the base 7, and the connector assembly 8 is fixed in the threaded column 15 by tightening the nut 16. In some implementations, the circuit board 3 may be connected with the base 7 in a fastened mode.

In some implementations, the base 7 is made of a metal material. For example, the base 7 is a magnesium-aluminum alloy base. In some implementations, a material of the base 7 is a resin material or a plastic material.

It needs to be noted that a distance between any two antennas is greater than half a wavelength of the two antennas, so that the two do not interfere with each other. The higher the frequency of the antenna, the shorter the wavelength of a corresponding signal, in which case the distance between the antennas may be set relatively short without interference. The lower the frequency of the antenna, the longer the wavelength of the corresponding signal, in which case the distance between the antennas needs to be set relatively longer. It can be seen that low and medium frequency antennas have higher requirements for a distance between the antennas, while a distance between medium and high frequency antennas may be set shorter.

Based on this, in the embodiment of the present application, when the combined antenna is arranged on a metal plate, the performance of the combined antenna may be degraded, wherein an extent of performance degradation is inversely proportional to a distance between the metal plate and the antenna, and inversely proportional to a magnitude of a frequency of the antenna. So low and medium frequency antennas may be arranged as second antennas 4 at a position at a long distance relative to the metal plate, and medium and high frequency antennas may be arranged as third antennas 5 at a position at a slightly shorter distance relative to the metal plate. Such a layout mode is conducive to eliminating an unfavorable influence of the metal plate on the signals of the low and medium frequency antennas, thus making the performance of the combined antenna more balanced.

In the embodiment of the present application, the circuit board 3 includes two side faces, wherein one side face is fixedly connected with the base 7, and the other side face is away from the base 7. In the embodiment of the present application, the side of the circuit board 3 connected with the base 7 is the side of the circuit board 3 facing the base 7, and the side of the circuit board 3 not connected with the base 7 is the side of the circuit board 3 away from the base 7.

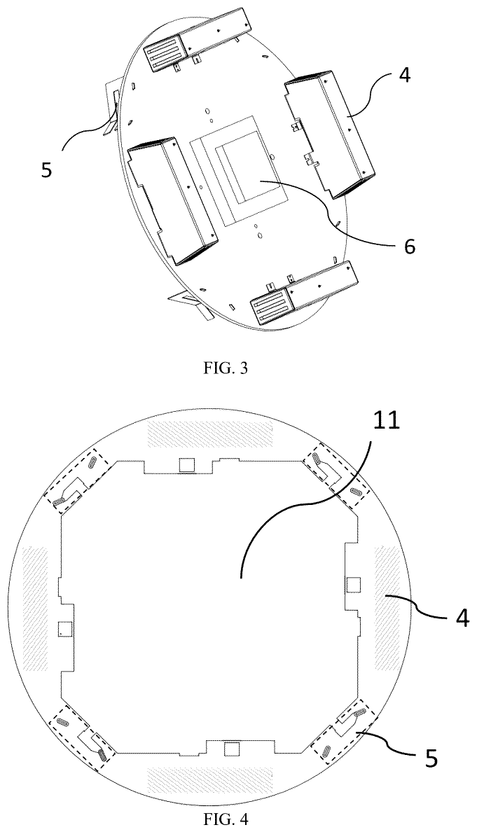

Referring to FIG. 1 and FIG. 3, FIG. 3 shows a first schematic diagram of a circuit board provided by an embodiment of the present application. A side of the circuit board 3 away from a base 7 includes a first antenna 6 and a plurality of second antennas 4, and a side of the circuit board 3 facing the base 7 includes a plurality of third antennas 5. The third antennas and the second antennas are alternately arranged on two sides of the circuit board.

In the embodiment of the present application, FIG. 3 exemplarily shows four second antennas 4 and four third antennas 5. According to FIG. 3, it can be seen that the third antennas 5 and the second antennas 4 are arranged spaced apart on two sides of the circuit board 3, e.g., any third antenna 5 is located between two adjacent second antennas 4, and/or any second antenna 4 is located between two adjacent third antennas 5.

It needs to be noted that in the embodiment of the present application, the number of the second antennas 4 and the number of the third antennas 5 may also be 2, 3, 5, and more or less, etc., and the present application does not limit the number of the second antennas 4 and the number of the third antennas 5.

As shown in FIG. 3, the first antenna 6 is located in a central area of the side of the circuit board 3 away from the base 7, and the four second antennas 4 are distributed around the first antenna 6. Each third antenna 5 is located between two adjacent second antennas 4.

In some implementations, as shown in FIG. 3, the number of the second antennas 4 is equal to the number of the third antennas 5. In some implementations, the number of the second antennas 4 and the number of the third antennas 5 may be unequal, e.g., the number of the second antennas is 4, and the number of the third antennas is 3. In a case of unequal numbers of the two, the second antennas 4 and the third antennas 5 still follow a principle of alternate arrangement and are kept at a distance as long as possible.

In some implementations, the plurality of second antennas 4 are identical antennas, and the plurality of second antennas 4 may be blind-mated. Similarly, the plurality of third antennas 5 are identical antennas, and the plurality of third antennas 5 may also be blind-mated.

In some implementations, the plurality of second antennas 4 may contain different types of antennas. The plurality of third antennas 5 may also contain different types of antennas.

In some implementations, the second antennas 4 and the third antennas 5 are all flexible circuit board antennas. In some implementations, the second antennas 4 are low and medium frequency antennas, and the third antennas 5 are medium and high frequency antennas.

In some implementations, the first antenna 6 is a ceramic high-precision positioning antenna.

In some implementations, the second antennas 4 are any one or more of a WiFi 2.4G antenna, a WiFi 5G antenna, a vehicle-to-everything (V2X) antenna, a long term evolution (LTE) 4G antenna, a 5G new radio (5G NR) antenna, a MIMO 5G antenna, and a Main 5G antenna. WiFi 2.4G refers to WiFi that operates in a 2.4 Ghz radio wave frequency band. WiFi 5G refers to WiFi that operates in a 5 Ghz radio wave frequency band.

In some implementations, the third antennas 5 are any one or more of a WiFi 2.4G antenna, a WiFi 5G antenna, a V2X antenna, an LTE 4G antenna, a 5G NR antenna, a MIMO 5G antenna, and a Main 5G antenna.

In some implementations, the plurality of second antennas 4 are distributed at equal intervals. Each third antenna 5 is located between two adjacent second antennas 4.

In some implementations, the plurality of third antennas 5 are also distributed at equal intervals.

In some implementations, when certain one second antenna 4 among the plurality of second antennas 4 is more important, the more important antenna may be defined as a target antenna, and a distance from the target antenna to two adjacent second antennas 4 is greater than a distance from a non-target antenna to two adjacent second antennas 4.

In some implementations, when certain one third antenna 5 among the plurality of third antennas 5 is more important, the more important antenna may be defined as a target antenna, and a distance from the target antenna to two adjacent third antennas 5 is greater than a distance from a non-target antenna to two adjacent third antennas 5.

In some implementations, a frequency coverage of the second antennas 4 is 600 MHz to 1000 MHz and 1450 MHz to 6000 MHz, and frequency bands of multiple standards such as 4G LTE, 5G NR, WiFi, V2X, and GPS are contained in the frequency range. A frequency coverage of the third antennas 5 is 1450 MHz to 6000 MHz, and frequency bands of multiple standards such as 4G LTE, 5G NR, WiFi, V2X, and GPS are contained in the frequency range. A frequency coverage of the first antenna 6 is a GPS L1 frequency band and a GPS L5 frequency band as well as a Beidou navigation satellite system (BDS) B1 frequency band, wherein the B1 frequency band is: 1559-1563 MHz, with a frequency point of 1561.098±2.046 MHz. In some implementations, the frequency coverage of the first antenna 6 is adjustable, which can cover the GPS L1 frequency band, the L5 frequency band, and the BDS B1 frequency band, and can also separately cover the GPS L1 frequency band, the GPS L5 frequency band, the BDS B1 frequency band, and other separate frequency bands. It needs to be noted that the first antenna 6, the second antennas 4, and the third antennas 5 may be any type of antenna, and the embodiment of the present application does not limit the type of the antennas integrated in the combined antenna.

In the embodiment of the present application, a user may select the types of the first antenna 6, the second antennas 4, and the third antennas 5 according to practical needs, and may freely combine different types of antennas according to practical needs, so that the combined antenna may meet needs of different signal frequency bands and different application scenarios.

In some implementations, the connector assembly 8 is an SMA connector cable assembly. In some implementations, the connector assembly 8 is connected to a microstrip line of the circuit board 3, and the first antenna 6, each second antenna 4, and each third antenna 5 are also connected to the microstrip line of the circuit board 3 respectively. The connector assembly 8 is connected with the first antenna 6, each second antenna 4, and each third antenna 5 respectively through the circuit board 3. In some implementations, the connector assembly 8 passes through the chassis of the base 7 and is connected with each antenna through the circuit board 3, and a connection between the connector assembly 8 and the base 7 is sealed with a glue.

In the embodiment of the present application, the first antenna 6, the second antennas 4, and the third antennas 5 are installed on the two sides of the circuit board 3, each third antenna 5 is located between two adjacent second antennas 4, thus on one hand, the isolation among the antennas is improved, and on the other hand, as many antennas as possible are arranged within a smallest possible space, which reduces space pressure on a communication system, thus enabling the combined antenna to be smaller and more ingenious so as to be suitable for a scenario where there is a requirement for a size of the antenna.

Based on the above embodiment, the embodiment of the present application describes a structure of the circuit board 3 in conjunction with accompanying drawings.

Referring to FIG. 4, FIG. 4 shows a second schematic diagram of a circuit board provided by an embodiment of the present application. In the embodiment of the present application, the circuit board 3 includes a substrate and a copper strip 11. The copper strip 11 is arranged on the substrate. The copper strip 11 is polygonal, and each edge corresponds to one second antenna 4 or corresponds to one third antenna 5. Areas where the second antennas 4 are located on a side of the circuit board 3 away from a base 7 are shown as shadow areas in FIG. 4, and areas where the third antennas 5 are located on a side of the circuit board 3 facing the base 7 are shown as dashed boxes in FIG. 4.

It needs to be noted that a polygon presented by the copper strip 11 in the embodiment of the present application is not an ideal polygon, each of its edges makes a minor shape adjustment based on an associated electrical structure, and these minor adjustments do not constitute a change in an overall shape of the copper strip 11.

This polygonal design makes full use of a reference ground on the circuit board 3 and increases an area of the reference ground, thus helping to obtain the better performance of an antenna.

In some implementations, the substrate may be in any shape, such as a rectangle, a square, a polygon, and a circle. As shown in FIG. 4, the substrate shown in FIG. 4 is in a disk shape. In some implementations, the substrate is a printed circuit board (PCB) 3. In some implementations, a material of the substrate is an FR-4 material, wherein the FR-4 material may be a fiberglass cloth. A thickness of a dielectric material is greater than 2 millimeters. A role of the dielectric material is to increase a distance between the antenna and the ground on one hand, and on the other hand, the dielectric material has a better dielectric constant, which helps to improve the performance of the antenna.

In some implementations, the copper strip 11 is in a shape of any polygon, such as a hexagon, a heptagon, an octagon, and a nonagon, and the present application does not limit the number of edges of the polygon. In other implementations, the copper strip 11 is in a shape of a regular polygon. For example, the copper strip 11 is in a shape of a regular octagon or a regular hexagon, etc. In other implementations, lengths of the individual edges of the copper strip 11 are unequal. In other implementations, the lengths of the individual edges of the copper strip 11 may be partially the same and partially different, as shown in FIG. 4.

In some implementations, the number of the edges of the copper strip 11 may be determined according to the total number of the second antennas 4 and the third antennas 5. For example, the total number of the second antennas 4 and the third antennas 5 is 8, and then the copper strip 11 is arranged to have 8 edges. For another example, the total number of the second antennas 4 and the third antennas 5 is 7, and then the copper strip 11 is arranged to have 7 edges.

In some implementations, a length of an edge of the copper strip 11 corresponding to an area where low and medium frequency antennas are located is greater than a length of an edge of the copper strip 11 corresponding to an area where medium and high frequency antennas are located. For example, referring to the copper strip 11 shown in FIG. 4, the low and medium frequency antennas serve as the second antennas 4, and the medium and high frequency antennas serve as the third antennas 5. Lengths of edges of the copper strip 11 corresponding to areas where the second antennas are located are greater than lengths of edges of the copper strip 11 corresponding to areas where the third antennas 5 are located. In some implementations, lengths of the edges of the copper strip 11 corresponding to the different second antennas 4 may be different. Lengths of the edges of the copper strip 11 corresponding to the different third antennas 5 may be different.

Based on the above embodiment, the combined antenna provided by the embodiment of the present application further includes an antenna bracket 13, wherein the antenna bracket 13 may be a plastic bracket or a bracket made of a resin material. The antenna bracket 13 is configured to support the second antennas 4 to isolate the second antennas 4 from the circuit board 3 by a certain distance. In some implementations, a height of the antenna bracket 13 is 10 mm to 25 mm.

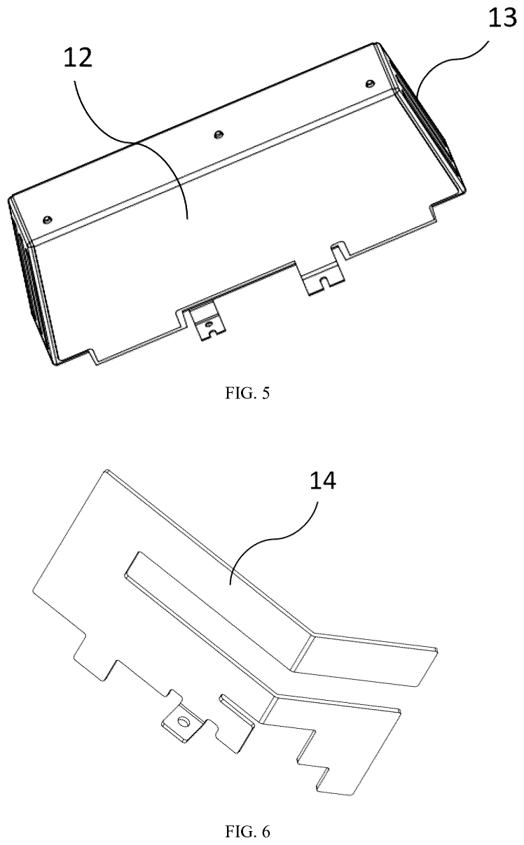

In some implementations, the second antennas 4 are implemented in a form of a combination of a flexible circuit board 12 and the antenna bracket 13. As shown in FIG. 5, FIG. 5 shows a schematic diagram of a connection between a second antenna and an antenna bracket. A flexible circuit board 12 of the second antenna is arranged on the antenna bracket 13, and then the antenna bracket 13 is welded to a circuit board 3.

In some implementations, the combined antenna provided by the embodiment of the present application further includes a connecting sheet 14, wherein a structure of the connecting sheet 14 is shown in FIG. 6, and the connecting sheet 14 is in an L shape. In some implementations, the connecting piece 14 is further provided with a slot and a step for adapting to a shape of a base 7. As can be seen in conjunction with FIG. 1, one side of the L-shaped connecting sheet 14 and the circuit board 3 are welded together, and the other perpendicular side is configured to arrange one third antenna 5.

In the embodiment of the present application, the connecting sheet 14 may be made of a metal material. For example, the connecting sheet 14 is an iron sheet or an aluminum alloy sheet. In some implementations, a height of the connecting sheet 14 is 10 mm to 25 mm.

In some implementations, the third antennas 5 are steel sheet antennas, and the connection of the antenna is completed through welding of the steel sheet antennas and the circuit board 3. This connection mode may effectively ensure that the combined antenna has a very good anti-vibration characteristic when it is used on various electronic devices.

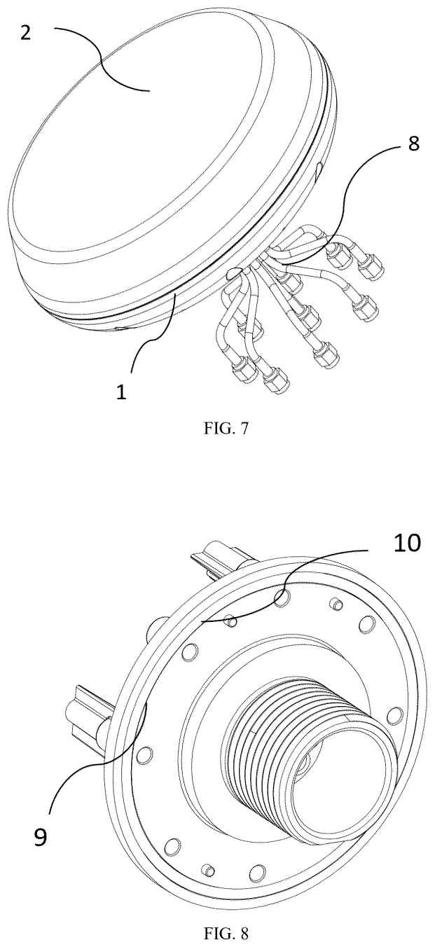

Based on the above embodiment, the combined antenna provided by the embodiment of the present application further includes a first housing 2 and a second housing 1. As shown in FIG. 7, FIG. 7 shows a first schematic diagram of an overall structure of a combined antenna provided by an embodiment of the present application. The first housing 2 and the second housing 1 are fastened to form an accommodating cavity, a circuit board 3 is located in the accommodating cavity, the second housing 1 includes a penetrating hole, and a base 7 is located in the penetrating hole and connected with the second housing 1.

In some implementations, the first housing 2 and the second housing 1 are metal housings. In other implementations, the first housing 2 and the second housing 1 are plastic housings or resin material housings.

In the embodiment of the present application, a shape of the first housing 2 and the second housing 1 may be any shape. In some implementations, the shape of the first housing 2 and the second housing 1 is the same as a shape of the circuit board 3. In some implementations, the first housing 2 and the second housing 1 are in a disk shape.

In the embodiment of the present application, one end of the base 7 supports the circuit board 3, and the other end is located in the penetrating hole and connected with the second housing 1. In some implementations, the base 7 is fixed to the second housing 1 through screws. In some implementations, a sealing assembly 10 is arranged between the base 7 and the second housing 1. In some implementations, the sealing assembly 10 is a sealing gasket, wherein the sealing gasket is, for example, a rubber ring. In some implementations, as shown in FIG. 8, FIG. 8 shows a schematic structural diagram of another base provided by an embodiment of the present application. The base 7 includes a chassis, wherein the chassis is provided with a clamp slot 9. A sealing assembly 10 is located in the clamp slot 9. The base 7, the sealing assembly 10, and a second housing 1 are in extruded contact.

In the embodiment of the present application, the sealing assembly is arranged between a first housing 2 and the second housing 1. The sealing assembly is a sealing gasket. The sealing gasket is, for example, a rubber ring. In the embodiment of the present application, the first housing 2 includes a necked-down portion, and the second housing 1 is fastened on the necked-down portion. The sealing assembly is arranged at the necked-down portion of the first housing 2. In some implementations, the necked-down portion of the first housing 2 is provided with a clamp slot, a sealing gasket is placed in the clamp slot, and the first housing 2, the sealing gasket, and the second housing 1 are extruded together.

In some implementations, the first housing 2 and the second housing 1 are fixed to each other through threads, e.g., the first housing 2 and the second housing 1 are provided with threaded holes, and screws pass through the threaded holes and cooperate with nuts to fix the first housing 2 and the second housing 1 together. In some implementations, the first housing 2 and the second housing 1 are clamped together. For example, the first housing 2 is provided with a clamp slot, the second housing 1 is provided with a clamp latch, and the clamp latch and the clamp slot are fastened together. In some implementations, the necked-down portion of the first housing 2 is provided with threads, and the second housing 1 is threadedly connected with the first housing 2.

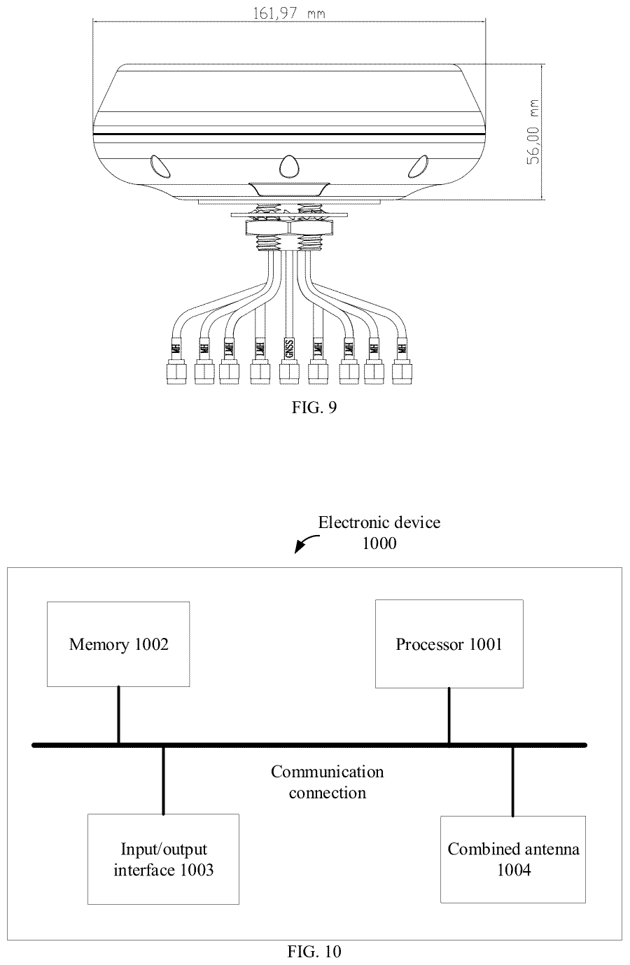

In an embodiment of the present application, as shown in FIG. 9, FIG. 9 shows a second schematic diagram of an overall structure of a combined antenna provided by an embodiment of the present application. A maximum diameter of a first housing 2 is 161.97 mm, and a height of a combination of the first housing 2 and a second housing 1 is 56.00 mm. As can be seen in FIG. 9, a circuit board 3 as well as a first antenna 6, second antennas 4, and third antennas 5 arranged on the circuit board 3 are all located in an accommodating cavity (not visible in FIG. 9), a part of a base 7 is located in the accommodating cavity (not visible in FIG. 9), and the other part extends out of the accommodating cavity. A connector assembly 8 is exposed outside the accommodating cavity through the base 7. In the embodiment of the present application, a size of the combined antenna is made very small to meet use needs in different scenarios.

Based on the above embodiments, an embodiment of the present application further provides an electronic device, including the combined antenna provided in the above embodiments. The electronic device may be, for example, an on-board device, or may be, for example, a roadside equipment, etc. As shown in FIG. 10, FIG. 10 shows a structural block diagram of an electronic device, wherein the electronic device includes a memory 1002, a processor 1001, an input/output interface 1003, and a combined antenna 1004. The memory 1002, the processor 1001, and the input/output interface 1003 are connected through an internal connection pathway. The memory 1002 is configured to store instructions, and the processor 1001 is configured to execute the instructions stored in the memory 1002. The combined antenna 1004 is configured to receive various forms of external signals.

It should be understood that in the embodiment of the present application, the processor 1001 may adopt a general-purpose central processing unit (CPU), a microprocessor, an application specific integrated circuit (ASIC), or one or more integrated circuits, for executing a related program.

The memory 1002 may include a read-only memory and a random access memory and provides instructions and data to the processor 1001. A part of the processor 1001 may also include a non-volatile random access memory. For example, the processor 1001 may also store information about the type of the device.

The processor may be a central processing unit (CPU), and the processor may further include another general-purpose processor, digital signal processor (DSP), application specific integrated circuit (ASIC), field programmable gate array (FPGA) or another programmable logic device, discrete gate or transistor logic device, discrete hardware component, etc. The general-purpose processor may include a microprocessor, or the processor may also include any conventional processor, etc.

Based on the above embodiment, an embodiment of the present application provides a miniaturized nine-in-one antenna. The nine-in-one antenna includes a circuit board, an aluminum-magnesium alloy base, and an SMA connector cable assembly, wherein the circuit board is fixed to the aluminum-magnesium alloy base through screws, a side of the circuit board away from the aluminum-magnesium alloy base is provided with four Main 5G antennas and one ceramic high-precision positioning antenna, and a side of the circuit board facing the aluminum-magnesium alloy base is provided with four MIMO 5G antennas. The one ceramic high-precision positioning antenna is located in a central area of the circuit board, and the four Main 5G antennas are distributed at equal intervals around the ceramic high-precision positioning antenna. The four MIMO 5G antennas are located between two adjacent Main 5G antennas respectively.

In the embodiment of the present application, the four Main 5G antennas, the four MIMO 5G antennas, the one ceramic high-precision positioning antenna are connected to a microstrip line of the circuit board respectively, and the SMA connector cable assembly is also connected to the microstrip line of the circuit board, so that the SMA connector cable assembly is connected with each antenna through the circuit board.

In the embodiment of the present application, the miniaturized nine-in-one antenna further includes a first housing and a second housing, wherein the first housing is clamped to the second housing, and a sealing gasket is arranged at a necked-down portion of the second housing. Furthermore, the first housing and the second housing are further fixed together through a plurality of screws. In the embodiment of the present application, the first housing and the second housing of the miniaturized nine-in-one antenna are in a disk shape.

In the embodiment of the present application, the first housing and the second housing are fastened to form an accommodating cavity, and the circuit board is located in the accommodating cavity. The second housing includes a penetrating hole, and the aluminum-magnesium alloy base is located in the penetrating hole. The aluminum-magnesium alloy base is fixed to the second housing through screws, and a sealing assembly is arranged between the aluminum-magnesium alloy base and the second housing.

In the embodiment of the present application, the four MIMO 5G antennas and the four Main 5G antennas may be blind-mated respectively, which ensures the simplicity and convenience of antenna assembling, and the antennas may be used according to practical needs. In the embodiment of the present application, each Main 5G antenna is composed of a flexible circuit board and a plastic bracket. In the embodiment of the present application, the MIMO 5G antennas are arranged on connecting sheets, and the connecting sheets are welded to the circuit board. The connecting sheets are configured to increase distances between the antennas and the ground of the circuit board, thus helping to improve the performance of the antennas.

In the embodiment of the present application, a frequency coverage of the Main 5G antennas is 600 MHz to 1000 MHz and 1450 MHz to 6000 MHz. A frequency coverage of the MIMO 5G antennas is 1450 MHz to 6000 MHz. A frequency coverage of the ceramic high-precision positioning antenna is a GPS L1 frequency band and a GPS L5 frequency band as well as a Beidou navigation satellite system (BDS) B1 frequency band, wherein the B1 frequency band is: 1559-1563 MHz, with a frequency point of 1561.098±2.046 MHz. In some implementations, the frequency coverage range of the ceramic high-precision positioning antenna is adjustable, which can cover the GPS L1 frequency band, the L5 frequency band, and the BDS B1 frequency band, and can also separately cover the GPS L1 frequency band, the GPS L5 frequency band, the BDS B1 frequency band, and other separate frequency bands.

In the embodiment of the present application, the four MIMO 5G antennas are implemented in a form of steel sheet antennas, the connection of the antennas is completed through welding of the steel sheet antennas and the circuit board, and such a connection mode may effectively ensure that the combined antenna has a very good anti-vibration characteristic when it is used on various vehicle systems.

In the embodiment of the present application, nine sets of antennas are arranged in a smallest possible space, wherein the four Main 5G antennas and one ceramic high-precision positioning antenna are arranged on the side of the circuit board away from the aluminum-magnesium alloy base, the four MIMO 5G antennas are arranged on the side of the circuit board facing the aluminum-magnesium alloy base, and the SMA connector cable assembly is connected with each antenna through the circuit board. Such a distribution mode can more reasonably use an internal space of the combined antenna and improve the isolation among the antennas, so as to miniaturize the combined antenna.

In addition, the Main 5G antennas are low frequency antennas whose signals are prone to being absorbed by a metal plate, thus affecting the performance of the antennas. In the embodiment of the present application, when the nine-in-one antenna is installed on a metal plate, since the extent of performance degradation caused by the antenna being close to the metal plate is inversely proportional to a distance between the metal plate and the antenna, and inversely proportional to a magnitude of the frequency of the antenna, a distance between the Main 5G antennas and the metal plate may be increased by arranging the Main 5G antennas on the side away from the metal aluminum-magnesium alloy base, which helps to reduce the absorption of a low frequency signal by the metal aluminum-magnesium alloy base. This results in the more balanced performance of the antenna.

The above is only the detailed description of the present application, but the scope of protection of the present application is not limited to this. Changes or replacements that can be easily figured out by any person skilled in the art within the technical scope disclosed in the present application should be covered in the scope of protection of the present application. Therefore, the scope of protection of the present application shall be subject to the scope of protection of the claims.

What is claimed is:

1. A combined antenna, comprising a circuit board, a base, and a connector assembly, wherein the circuit board is fixedly connected with the base, a side of the circuit board away from the base comprises a first antenna and a plurality of second antennas, a side of the circuit board facing the base comprises a plurality of third antennas, the first antenna is located in a central area of the side of the circuit board away from the base, the plurality of second antennas are located around the first antenna, and the second antennas and the third antennas are alternately arranged on two sides of the circuit board;
wherein the connector assembly is connected with the first antenna, each of the second antennas, and each of the third antennas respectively through the circuit board.

2. The combined antenna according to claim 1, wherein the plurality of second antennas are distributed at equal intervals.

3. The combined antenna according to claim 1, wherein a distance from a target antenna in the third antennas to an adjacent third antenna is greater than a distance from a non-target antenna in the third antennas to an adjacent third antenna.

4. The combined antenna according to claim 2, wherein a distance from a target antenna in the third antennas to an adjacent third antenna is greater than a distance from a non-target antenna in the third antennas to an adjacent third antenna.

5. The combined antenna according to claim 1, wherein the number of the second antennas is equal to the number of the third antennas.

6. The combined antenna according to claim 2, wherein the number of the second antennas is equal to the number of the third antennas.

7. The combined antenna according to claim 3, wherein the number of the second antennas is equal to the number of the third antennas.

8. The combined antenna according to claim 4, wherein the number of the second antennas is equal to the number of the third antennas.

9. The combined antenna according to claim 1, wherein the circuit board comprises a substrate and a copper strip, wherein the copper strip is arranged on a side of the substrate away from the base, the copper strip is polygonal, and one second antenna or one third antenna is distributed in an area corresponding to each edge of the copper strip.

10. The combined antenna according to claim 2, wherein the circuit board comprises a substrate and a copper strip, wherein the copper strip is arranged on a side of the substrate away from the base, the copper strip is polygonal, and one second antenna or one third antenna is distributed in an area corresponding to each edge of the copper strip.

11. The combined antenna according to claim 3, wherein the circuit board comprises a substrate and a copper strip, wherein the copper strip is arranged on a side of the substrate away from the base, the copper strip is polygonal, and one second antenna or one third antenna is distributed in an area corresponding to each edge of the copper strip.

12. The combined antenna according to claim 4, wherein the circuit board comprises a substrate and a copper strip, wherein the copper strip is arranged on a side of the substrate away from the base, the copper strip is polygonal, and one second antenna or one third antenna is distributed in an area corresponding to each edge of the copper strip.

13. The combined antenna according to claim 5, wherein the circuit board comprises a substrate and a copper strip, wherein the copper strip is arranged on a side of the substrate away from the base, the copper strip is polygonal, and one second antenna or one third antenna is distributed in an area corresponding to each edge of the copper strip.

14. The combined antenna according to claim 6, wherein the circuit board comprises a substrate and a copper strip, wherein the copper strip is arranged on a side of the substrate away from the base, the copper strip is polygonal, and one second antenna or one third antenna is distributed in an area corresponding to each edge of the copper strip.

15. The combined antenna according to claim 7, wherein the circuit board comprises a substrate and a copper strip, wherein the copper strip is arranged on a side of the substrate away from the base, the copper strip is polygonal, and one second antenna or one third antenna is distributed in an area corresponding to each edge of the copper strip.

16. The combined antenna according to claim 9, wherein a length of an edge of the copper strip corresponding to an area where each of the second antennas is located is greater than a length of an edge of the copper strip corresponding to an area where each of the third antennas is located.

17. The combined antenna according to claim 9, wherein the copper strip is octagonal.

18. The combined antenna according to claim 1, further comprising an antenna bracket, wherein the antenna bracket is arranged between the second antennas and the circuit board.

19. The combined antenna according to claim 1, further comprising a first housing and a second housing, wherein the first housing and the second housing are fastened to form an accommodating cavity, the circuit board is located in the accommodating cavity, the second housing comprises a penetrating hole, and the base is located in the penetrating hole and connected with the second housing.

20. An electronic device, comprising:
the combined antenna according to claim 1.
